(19) United States
(12) Patent Application Publication
(10) Pub. No.: US 2019/0113801 A1
(43) Pub. Date: Apr. 18, 2019

(54) OPTICAL ELEMENT AND OPTICAL APPARATUS

(71) Applicant: CANON KABUSHIKI KAISHA, Tokyo (JP)

(72) Inventor: Satoshi Ito, Utsunomiya-shi (JP)

(21) Appl. No.: 16/154,781

(22) Filed: Oct. 9, 2018

(30) Foreign Application Priority Data
Oct. 12, 2017 (JP) 2017-198134

(51) Int. Cl. G02F 1/1335; G02F 1/19; G02B 27/09

(52) U.S. Cl. CPC G02F 1/133526; G02B 27/0955; G02F 1/19

(57) ABSTRACT

An optical element 100 is an optical element switchable between a first state and a second state and includes a first material 110 having a first refractive index and a first Abbe's number and a second material 120 having a second refractive index and a second Abbe's number, wherein the first refractive index, the second refractive index, the first Abbe's number, and the second Abbe's number satisfy predetermined conditions.

### BACKGROUND OF THE INVENTION

### Field of the Invention

The present invention relates to a liquid crystal diffraction lens.

### Description of the Related Art

At the present day, there are glasses using a fixed focal length lens, bifocal progressive lens, double focus lens, or the like, which can adjust power so as to be focused at a close range and an infinite distance, as reading glasses that are generally distributed. Japanese Patent Application Laid-open No. 2013-137544 discloses glasses using an electro-active element (liquid crystal diffraction lens) which makes power of a presbyopia power unit variable and applies power to the presbyopia power unit only for seeing a close range (near distance) such as a reading distance, without applying power to the presbyopia power unit for seeing a far distance such as an infinite distance.

However, the liquid crystal diffraction lens disclosed in Japanese Patent Laid-open No. 2013-137544 uses a combination of a liquid crystal material with low refractive index and low dispersion and a substrate with high refractive index and high dispersion to sandwich a diffraction surface in an electro-active state, and accordingly it is difficult to achieve a high diffraction efficiency over a wide wavelength band.

### SUMMARY OF THE INVENTION

The present invention provides an optical element and an optical apparatus having a high diffraction efficiency over a wide wavelength band.

An optical element as one aspect of the present invention is an optical element switchable between a first state and a second state, the optical element comprising: a first material having a first refractive index and a first Abbe's number; and a second material having a second refractive index and a second Abbe's number, wherein the first refractive index, the second refractive index, the first Abbe's number, and the second Abbe's number satisfy predetermined conditions.

An optical apparatus as another aspect of the present invention has the above optical element and a controller configured to set the optical element to be in the first state or the second state.

Further features of the present invention will become apparent from the following description of exemplary embodiments with reference to the attached drawings.

### BRIEF DESCRIPTION OF THE DRAWINGS

FIG. 1 is a configuration diagram of an optical element in this embodiment.

FIG. 2 shows a refractive index and Abbe's number of each material constituting the optical element in this embodiment.

FIGS. 3A-3C show a diffraction efficiency of the optical element in this embodiment.

FIG. 4 shows a refractive index and Abbe's number of each material constituting an optical element as a modification in this embodiment.

FIGS. 5A-5C show a diffraction efficiency of the optical element as the modification in this embodiment.

FIG. 6 is a schematic diagram of an optical apparatus in this embodiment.

FIG. 7 is a configuration diagram of an optical element as a comparative example.

FIG. 8 shows a refractive index and Abbe's number of each material constituting an optical element as the comparative example.

FIG. 9 shows a diffraction efficiency of the optical element as the comparative example.

### DESCRIPTION OF THE EMBODIMENTS

Exemplary embodiments of the present invention will be described below with reference to the accompanied drawings.

First of all, referring to FIGS. 7 to 9, an optical element (liquid crystal diffraction lens or electro-active lens) as a comparative example will be described.

FIG. 7 is a configuration diagram (cross-sectional view) of the liquid crystal diffraction lens 200 as the comparative example. The liquid crystal diffraction lens 200 includes a substrate 220 that has an approximately flat surface, a substrate 221 that has a relief surface, and a liquid crystal material 210 that is provided between the substrate 220 and the substrate 221. Surfaces of the two substrates 220 and 221 facing the liquid crystal material 210 are coated with optically-transparent single electrodes 230 and 231.

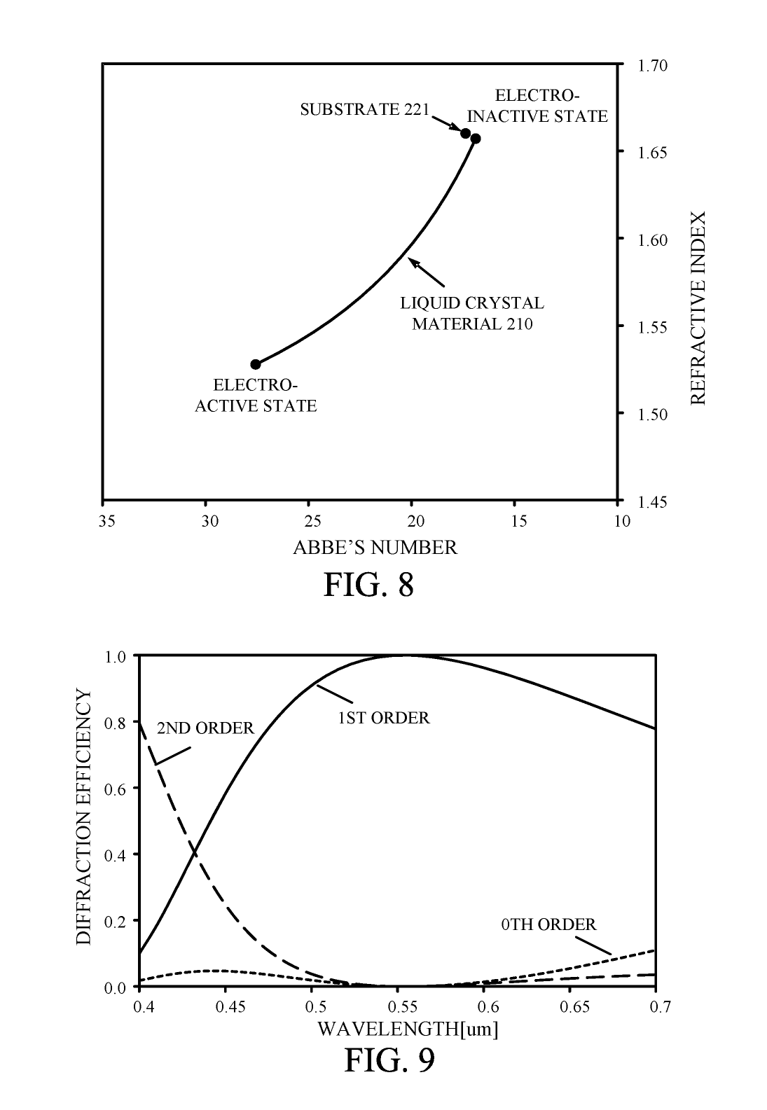

FIG. 8 is a refractive index and an Abbe's number of each material (substrate 221 and liquid crystal material 210) constituting the optical element as the comparative example. As illustrated in FIG. 8, the refractive index and the Abbe's number of the substrate 221 are set to approximately coincide with the refractive index and the Abbe's number of the liquid crystal material 210 in the electro-inactive state, and on the other hand the refractive index of the liquid crystal material 210 is varied to generate power in the electro-active state. However, the liquid crystal diffraction lens of this configuration is constituted by the combination of the liquid crystal material with low refractive index and low dispersion and the substrate with high refractive index and high dispersion to sandwich a diffraction surface in the electro-active state, and accordingly it is difficult to obtain a high diffraction efficiency over a wide wavelength band. In this embodiment, the diffraction efficiency is defined as a ratio of a light beam propagating in each diffraction direction with respect to an incident light beam.

FIG. 9 is a diffraction efficiency of the optical element (liquid crystal diffraction lens 200) as the comparative example. While the diffraction efficiency of 1st-order light as a design order is high with respect to the wavelength of 550 nm as a design wavelength, it is decreased with respect to the wavelength distant from the design wavelength and especially it is greatly decreased with respect to the short wavelength band. The light corresponding to the decrease of the diffraction efficiency of the design order light becomes light with other diffraction orders. Light other than the design order light becomes flare light which decreases contrast. Accordingly, when the liquid crystal diffraction lens 200 is used in reading or the like, the flare caused by undesired diffracted light (0th-order light or 2nd-order light) becomes prominent and the visibility of characters is decreased, and thus it is not preferable.

The optical element (liquid crystal lens or electro-active lens) of this embodiment has at least two optical states (first state and second state). The optical state means optical power (focal length) of the electro-active lens, and the electro-active lens has power that varies between the electro-inactive state (first state) and the electro-active state (second state). As a representative example, while it does not substantially have power in the electro-inactive state, it has desired power (for example +3D) in the electro-active state. By using such an electro-active lens in reading glasses (optical apparatus), it is possible to apply power to a presbyopia power unit only for seeing a close range (near distance) such as a reading distance, while not to apply power to the presbyopia power unit for seeing a far distance such as an infinite distance.

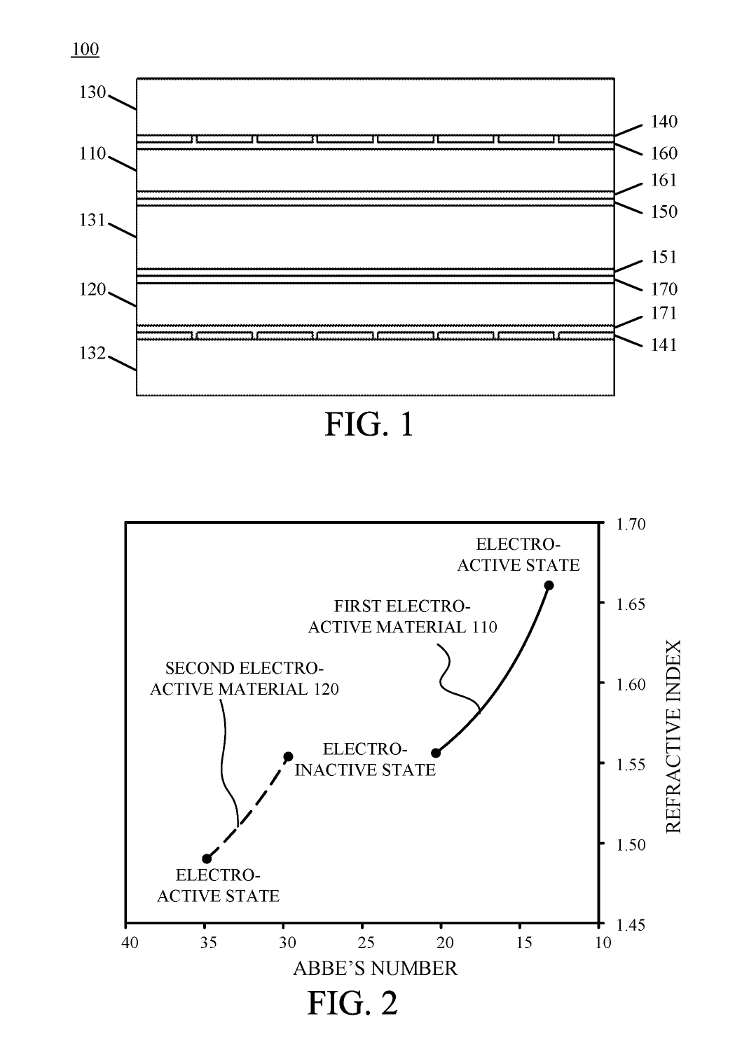

Next, referring to FIGS. 1 to 3C, an optical element (electro-active lens) in this embodiment will be described.

The optical element of this embodiment is a liquid crystal diffraction lens having a variable focusing function. FIG. 1 is a configuration diagram (cross-sectional view) of the optical element (electro-active lens 100) in this embodiment.

The electro-active lens 100 includes a first electro active material 110 (first material or liquid crystal material) having a first refractive index and a first Abbe's number and a second electro-active material 120 (second material or liquid crystal material) having a second refractive index and a second Abbe's number.

Furthermore, the electro-active lens 100 includes substrates 130, 131, and 132 provided so as to sandwich the first electro-active material 110 and the second electro-active material 120 to hold the first electro-active material 110 and the second electro-active material 120.

The electro-active lens 100 includes optically-transparent and segmented electrodes 140 and 141 that are provided close to the first electro-active material 110 or the second electro-active material 120. The segmented electrodes 140 and 141 preferably has a concentric shape in eyeglass applications. Furthermore, the electro-active lens 100 includes optically-transparent single electrodes 150 and 151 that are provided close to the first electro-active material 110 or the second electro-active material 120. Each of the optically-transparent electrodes 140, 141, 150, and 151 is constituted by for example ITO. The electrodes 140 and 150 are a pair of first transparent electrodes that are provided so as to sandwich the first electro-active material. The electrodes 141 and 151 are a pair of second transparent electrodes that are provided so as to sandwich the second electro-active material 120.

The electrodes 140, 141, 150, and 151 apply a predetermined voltage to each of the first electro-active material 110 and the second electro-active material 120 and vary the refractive index and the Abbe's number of each of the first electro-active material 110 and the second electro-active material 120 to desired values. Thus, each of the first electro-active material 110 and the second electro-active material 120 varies between the electro-inactive state and the electro-active state, depending on the applied voltage. When different voltages are applied to the segmented electrodes 140 and 141 depending on the segment, a refractive index distribution can be imparted to each of the first electro-active material 110 and the second electro-active material 120. According to this configuration, it is possible to impart the effect as a diffractive lens to each of the first electro-active material 110 and the second electro-active material 120.

An alignment film may be provided on a surface contacting the corresponding electro-active material of surfaces of each of the electrodes 140, 141, 150, and 151, and according to this configuration, the orientation of the electro-active material can be controlled. The electro-active lens 100 has alignment films 160 and 161 in contact with the first electro-active material 110. In addition, the electro-active lens 100 has alignment films 170 and 171 in contact with the second electro-active material 120.

The electro-active lens 100 is formed by laminating a first diffraction lens made of the first electro-active material 110 and a second diffraction lens made of the second electro-active material 120. In the electro-active lens having such a configuration, the diffraction efficiency in the electro-active state will be explained using equations. In order to maximize the diffraction efficiency at a vertical incidence (incidence in the vertical direction in FIG. 1) in a laminated-type electro-active lens, the sum of the difference in the optical path length of the two diffraction lenses should be an integral multiple of the wavelength. Then, the following equation (1) holds.

Δn1(λ0)d1+Δn2(λ0)d2=mλ0 (1)

In the equation (1), λ0 represents a designed wavelength, d1 and d2 represent the heights of the first electro-active material and the second electro-active material, respectively, and m represents a diffraction order. Also, Δn1(λ0) and Δn2(λ0) represent maximum refractive index differences of the refractive index distributions in the electro-active state of the first electro-active material and the second electro-active material, respectively.

The diffraction efficiency ηₘ of the mth order at another wavelength λ at which the equation (1) is not satisfied is expressed by the following equation (2).

ηₘ(λ)=sin c²(φ(λ)−m), (2)

where

sin c(x)=sin(πx)/(πx), (3)

φ(λ)=φ1(λ)+φ2(λ), (4)

φ1(λ)=Δn1(λ)d1/λ, and (5)

φ2(λ)=Δn2(λ)d2/λ (6)

Where the equation (1) is satisfied for all the wavelengths λ, the diffraction efficiency 11 does not depend on the wavelengths. When the design order is m=1 and the equation (1) is satisfied for each of the d-, C-, F-lines, the following equation (7) is derived.

(Δn1(λd)+cΔn2(λd))/{(Δn1(λF)−Δn1(λC))+c(Δn2(λF)−Δn2(λC))}=λd/(λF−λC) (7)

In Equation (7), λd, λC, and λF represent the wavelengths of the d-, C-, and F-lines, respectively. Here, note that the derivation of the equation (7) needs d2=cd1. The term Δn(λF)−Δn(λC) (omitted suffixes for simplicity) included in the left-side denominator of the equation (7) can be rewritten as shown in the following equation (8).

Δn(λF)−Δn(λC)=(n′(λF)−n′(λC))−(n(λF)−n(λC)) (8)

In the equation (8), n(λ) and n′(λ) represent refractive indices of adjacent regions which give the maximum refractive index difference of the refractive index distribution, respectively. From the equation (8), it is understood that the term included in the left-hand side denominator of the equation (7) corresponds to the difference in the Abbe's numbers between the adjacent regions. The right-hand side of the equation (7) is a constant, and λd/(λF−λC)=−3.45. Therefore, in order to satisfy the equation (7) under the condition of c>1, there is a need to choose a combination of the electro-active materials such that the differences in the refractive indices and the Abbe's numbers between the adjacent regions which give the maximum refractive index difference of the refractive index distribution have opposite signs. Under such a configuration, it is possible to realize a high diffraction efficiency over a wide wavelength range.

In this embodiment, the first refractive index n1 and the second refractive index n2 in the electro-active state satisfy the following equation (9).

n1>n2 (9)

In this embodiment, the first Abbe's number ν1 and the second Abbe's number ν2 in the electro-active state satisfy the following equation (10).

ν1<ν2 (10)

In the equation (9), the first refractive index n1 and the second refractive index n2 are values for d-line, respectively. In the equation (10), the first Abbe's number ν1 and the second Abbe's number ν2 are the first Abbe's number and the second Abbe's number with d-line as a reference wavelength, respectively.

FIG. 2 shows the refractive index and the Abbe's number of the materials (the first electro-active material 110 and the second electro-active material 120) constituting the electro-active lens 100. In FIG. 2, the solid line corresponds to the first electro-active material 110 and the dash line corresponds to the second electro-active material 120. In the electro-active state, the first refractive index n1 and the first Abbe's number ν1 of the first electro-active material 110 are n1=1.556 and ν1=20.32, respectively. In the electro-inactive state, the second refractive index n2 and the second Abbe's number ν2 of the second electro-active material 120 are n2=1.554 and ν2=29.68, respectively.

In the electro-active lens 100, the first electro-active material 110 has the first refractive index and the first Abbe's number which vary between the electro-inactive state (first state) and the electro-active state (second state). Similarly, the second electro-active material 120 has the second refractive index and the second Abbe's number which vary between the electro-inactive state and the electro-active state.

In addition, different voltages are applied to the segmented electrodes 140 and 141 for each segment, and a refractive index distribution is given to each of the first electro-active material 110 and the second electro-active material 120. With such a configuration, in the electro-active state, each of the first electro-active material 110 and the second electro-active material 120 acts as a refractive-index-distribution-type diffraction lens, and generates power in the electro-active lens 100.

In this embodiment, when the electro-inactive state is varied to the electro-active state, in a region where a sufficiently high voltage is applied, the first refractive index n1 and the first Abbe's number ν1 of the first electro-active material 110 vary so that n1=1.661 and ν1=13.15, respectively. At this time, the variation amount Δn1 of the first refractive index and the variation amount Δν1 of the first Abbe's number are Δn1=0.101 and Δν1=−7.17, respectively. Similarly, in a region where a sufficiently high voltage is applied, the second refractive index n2 and the second Abbe's number ν2 of the second electro-active material 120 vary so that n2=1.490 and ν2=34.85, respectively. At this time, the variation amount Δn2 of the second refractive index and the variation amount Δν2 of the second Abbe's number are Δn2=−0.064 and Δν2=5.17, respectively. With such a configuration, the combination of the electro-active materials can be obtained so that the difference in refractive index and the difference in Abbe's number between adjacent regions which gives the maximum refractive index difference of the refractive index distribution have opposite signs, and a high diffraction efficiency can be realized over a wide wavelength band.

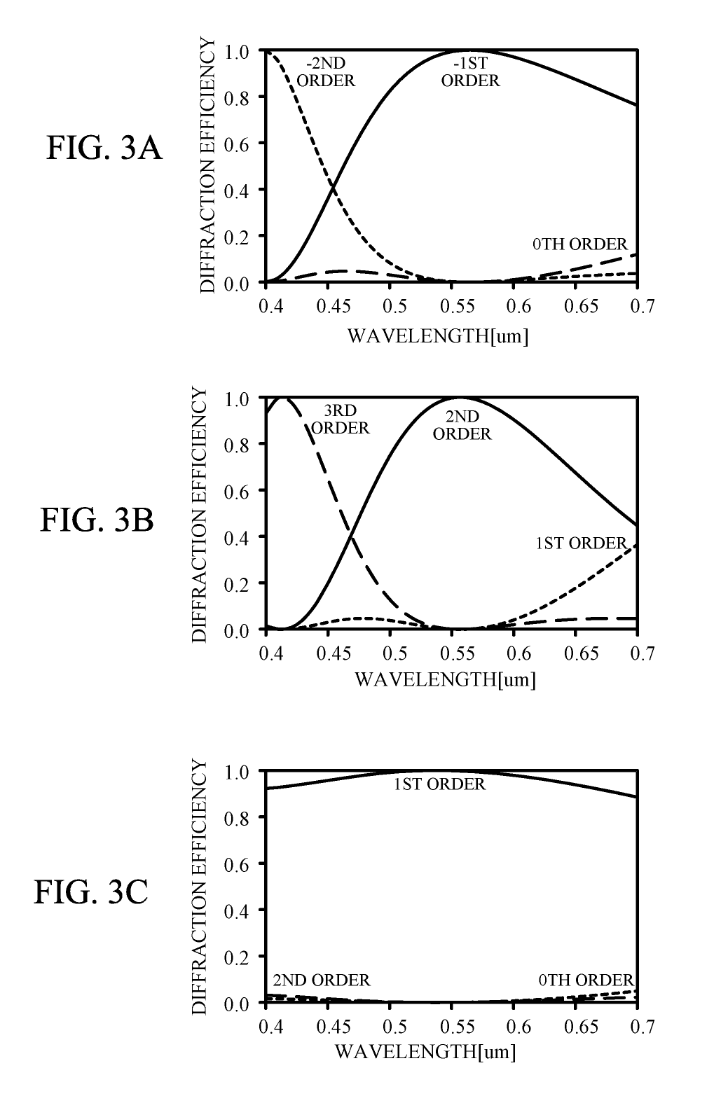

FIG. 3A shows the diffraction efficiency of the diffraction lens made of the first electro-active material and FIG. 3B shows the diffraction efficiency of the diffraction lens made of the second electro-active material. From FIGS. 3A and 3B, it is understood that light is diffracted to a plurality of diffraction orders in the visible range. If the indicators of the orders are hidden, the two figures are very similar. This means that the peak wavelength of each diffraction order is substantially equal for the two diffraction lenses. In the diffractive lens made of the first electro-active material, the peak wavelength of the −1st order diffracted light is 565 nm, and the peak wavelength of the −2nd order diffracted light is 400 nm. The height d1 of the first electro-active material is d1=5.2 μm. On the other hand, in the diffraction lens made of the second electro-active material, the peak wavelength of the 2nd order diffracted light is 557 nm, and the peak wavelength of the 3rd order diffracted light is 413 nm. Thus, it can be seen that these are substantially equal. The height d2 of the second electro-active material is d2=17.2 μm. With such a configuration, it is possible that the light flux diffracted to the negative diffraction order by the diffraction lens made of the first electro-active material is diffracted to a larger positive diffraction order by the diffraction lens made of the second electro-active material, and then the electro-active lens 100 can diffract the light flux to a specific diffraction order (design order). Thus, by arranging the diffraction lenses made of the two electro-active materials closely to each other, the light flux incident on the first electro-active material enters the second electro-active material before it is completely diffracted to a plurality of diffraction orders, so that it is possible to have a high diffraction efficiency in a composite diffraction order.

FIG. 3C shows a diffraction efficiency of the electro-active lens 100 obtained by combining the first electro-active material and the second electro-active material. As is obvious from FIG. 3C, as compared with the liquid crystal diffraction lens 200 (FIG. 9) as a comparative example, diffraction efficiency of the 1st-order diffracted light is improved in a short wavelength and a long wavelength, in particular the diffraction efficiency is greatly improved in a short wavelength side. As a result, it is possible to reduce flare due to undesired diffracted light (0th-order diffracted light or 2nd-order diffracted light), and to improve visibility.

In the electro-active lens 100, the first electro-active material 110 preferably has a negative dielectric anisotropy, and the second electro-active material 120 preferably has a positive dielectric anisotropy. Further, the alignment film in contact with the first electro-active material 110 is preferably a vertically alignment film, and the alignment film in contact with the second electro-active material 120 is preferably a horizontally alignment film. With such a configuration, it is possible to obtain a combination of two electro-active materials in which a variation in the refractive index and a variation in the Abbe's number each has a different (opposite) direction when a voltage is applied to the electro-active materials. This makes it possible to realize high diffraction efficiency over a wide wavelength range.

In the electro-active lens 100, it is preferable that the first electro-active material 110 and the second electro-active material 120 each has a birefringence index of 0.10 or more. A uniaxial optical material such as a liquid crystal has an ordinary refractive index no and an extraordinary refractive index ne and its birefringence index is defined as a difference ne−no between the both. In this embodiment, as the first electro-active material 110, a material having an ordinary refractive index no of no=1.556 and an extraordinary refractive index ne of ne=1.765 is used. As the second electro-active material 120, a material having an ordinary refractive index no of no=1.490 and an extraordinary refractive index ne of ne=1.618 is used.

In this case, the birefringence of the first electro-active material 110 is 0.209 and the birefringence of the second electro-active material 120 is 0.128. In this manner, by using an electro-active material having a birefringence of 0.10 or more, it is possible to widen a dynamic range of a variation in the refractive index due to the change from the electro-inactive state to the electro-active state, and it is possible to easily control the refractive index in the electro-active state.

In the electro-active lens 100, the thickness dsub of the substrate 131 provided between the first electro-active material 110 and the second electro-active material 120 preferably satisfies the following condition (11).

30 μm≤dsub≤300 μm (11)

If the thickness of the substrate 131 is less than the lower limit of the condition (11), it is not preferable because the significant difficulty in laminating two electro-active materials is caused. Also, when the thickness of the substrate 131 exceeds the upper limit of the condition (11), the light flux entering into the diffraction lens made of the first electro-active material is completely diffracted to a plurality of diffraction orders. This makes it difficult to increase a combined diffraction efficiency of the electro-active lens having the laminated structure, which is not preferable.

If voltage cannot be applied to an electro-active material due to failure or power consumption, an influence on the user of the electro-active lens must be avoided. Normal reading glasses correct the vision of a user so that a focus is on a far point such as infinity and then add to the presbyopia power unit the shortage of accommodation ability when the focus is shifted to a near point such as a reading distance. For this reason, it is preferable that in an electro-inactive state where no voltage is applied to the electroactive material, any power is not applied to the electro-active lens, and in an electro-active state where a voltage is applied to the electro-active material, power is added to the electro-active lens. With such a configuration, even in a situation where a voltage cannot be applied to the electro-active material due to a failure or the like, the electro-active lens is initialized to a state in which the electro-active lens is focused on a far point, and it becomes possible to avoid an influence on a user.

To realize such a configuration, in the electro-active lens 100, preferably, the difference between the first refractive index n1 and the second refractive index n2 in the electro-inactive state is smaller than the difference between the refractive index n1 and the second refractive index n2 in the electro-active state. Also, preferably, the first refractive index n1 and the second refractive index n2 in the electro-inactive state are substantially equal to each other. With such a configuration, no refractive power is generated in the electro-active lens in the electro-inactive state, and it becomes possible to correctly focus on the far point.

In the electro-active lens 100, each of the first electro-active material 110 and the second electro-active material 120 are preferably a cholesteric liquid crystal or a nematic liquid crystal to which a chiral twisting agent is added. As with the nematic liquid crystal, the cholesteric liquid crystal is optically uniaxial and has birefringence. However, with respect to the cholesteric liquid crystal, a director of the liquid crystal molecule spirally rotates in a thickness direction of the liquid crystal material. The length along a rotation axis until the director of the liquid crystal molecule rotates 360° is called a twist pitch. The cholesteric liquid crystal has an average refractive index nave=(no+ne)/2 for a light wave having a wavelength corresponding to the twist pitch and propagating perpendicularly to the director of the liquid crystal molecule. When a sufficiently strong voltage is applied, the director of the liquid crystal molecule becomes parallel to the applied electric field. For this reason, the cholesteric liquid crystal has an ordinary refractive index no for light wave propagating in the electric field direction. Therefore, the cholesteric liquid crystal changes the orientation of the liquid crystal molecule according to the applied electric field intensity, and has a refractive index value between the average refractive index nave and the ordinary refractive index no for the light wave propagating along the rotation axis of the director.

In addition, by adding a chiral twist agent to the nematic liquid crystal, it is possible to obtain characteristics equivalent to those of the cholesteric liquid crystal. The nematic liquid crystal to which the chiral twist agent is added has an ordinary refractive index no and an extraordinary refractive index ne which are the same as those of the original nematic liquid crystal and it is possible to adjust the twist pitch to a desired value by a helical twisting force of the chiral twist agent to be added. Since the average refractive index nave of the cholesteric liquid crystal and the nematic liquid crystal to which the chiral twist agent is added are a constant value independent of a polarization state of an incident light wave, the cholesteric liquid crystal and the nematic liquid crystal to which the chiral twist agent is added has polarization insensitivity. Therefore, by using the cholesteric liquid crystal or the nematic liquid crystal to which the chiral twist agent is added as the first electro-active material 110 or the second electro-active material 120, it becomes possible to add a uniform convergence force with respect to randomly polarized light waves.

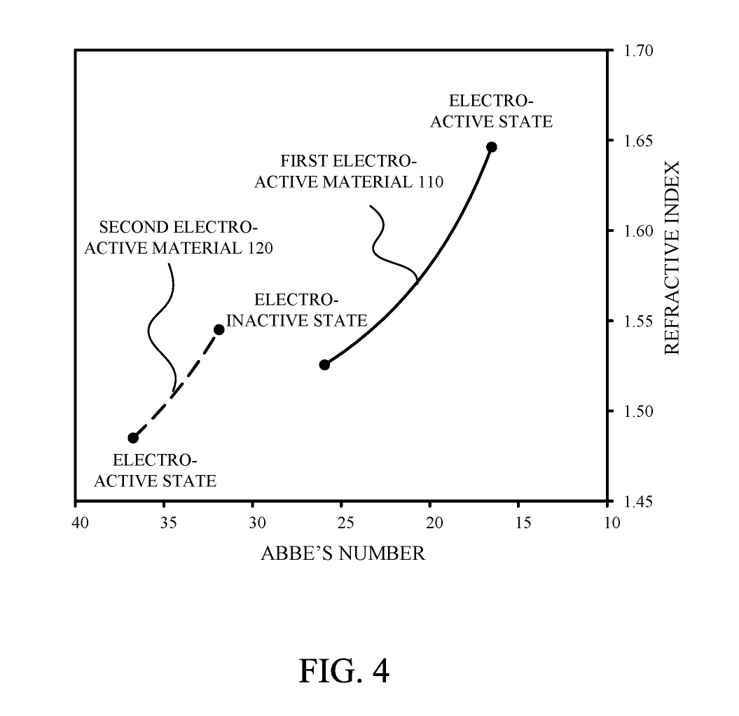

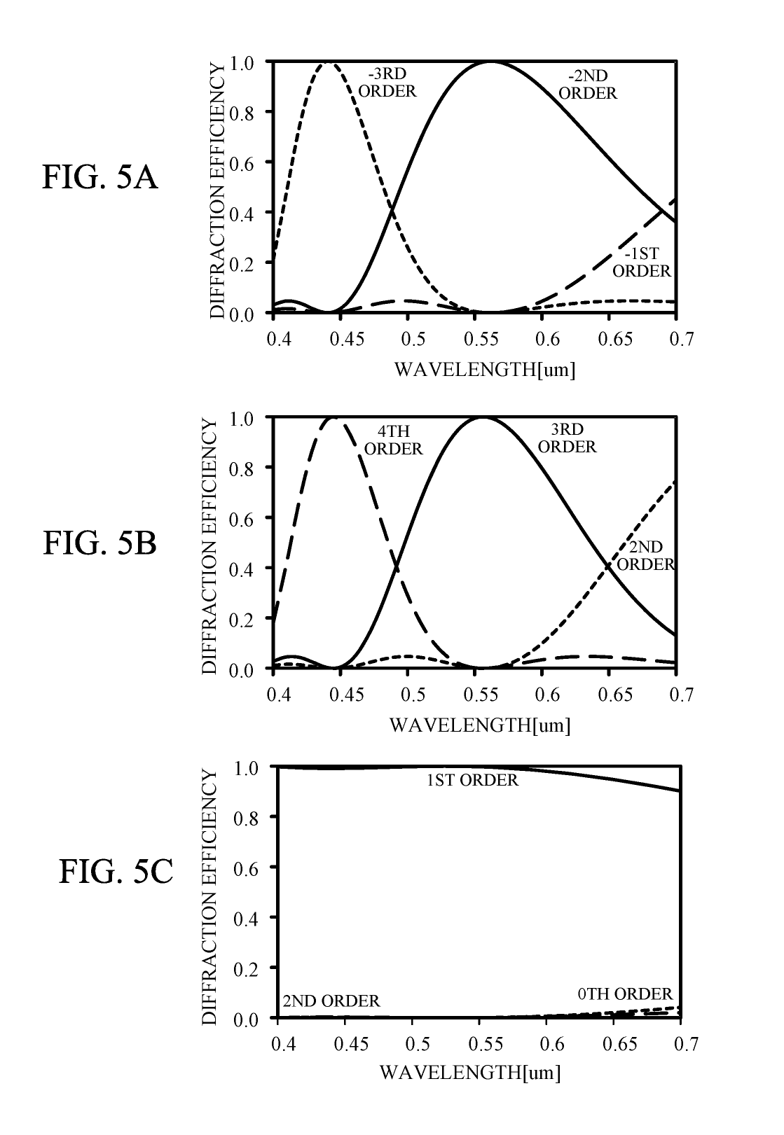

Next, with reference to FIGS. 4 to 5C, a description will be given of an optical element (electro-active lens or liquid crystal diffraction lens) as a modification of this embodiment. FIG. 4 shows a refractive index and an Abbe's number of each material (first electro-active material 110 and second electro-active material 120) constituting the electro-active lens 100. In FIG. 4, the solid line corresponds to the first electro-active material 110 and the dash line corresponds to the second electro-active material 120. In an electro-inactive state, the first refractive index n1 and the first Abbe's number ν1 of the first electro-active material 110 are n1=1.526 and ν1=25.94, respectively. In the electro-inactive state, the second refractive index n2 and the second Abbe's number ν2 of the second electro-active material 120 are n2=1.545 and ν2=31.89, respectively.

In the electro-active lens 100, a liquid crystal material with ne=1.767 and no=1.526 is used as the first electro-active material 110 and a liquid crystal material with ne=1.605 and no=1.485 is used as the second electro-active material 120. In this embodiment, when varying from the electro-inactive state to the electro-active state, in an area where a sufficiently high voltage is applied, a first refractive index n1 and a first Abbe's number ν1 of the first electro-active material 110 vary to n1=1.646 and ν1=16.51, respectively. Then, a variation amount Δn1 of the first refractive index and a variation amount Δν1 of the first Abbe's number are Δn1=0.120 and Δν1=−9.43, respectively. Similarly, in an area where a sufficiently high voltage is applied, a second refractive index n2 and a second Abbe's number ν2 of the second electro-active material 120 vary to n2=1.485 and ν2=36.73, respectively. Then, a variation amount Δn2 of the second refractive index and a variation amount Δν2 of the second Abbe's number are Δn2=−0.060 and Δν2=4.84, respectively. With such a configuration, the combination of the electro-active materials can be obtained so that the difference in refractive index and the difference in Abbe's number between adjacent regions which gives the maximum refractive index difference of the refractive index distribution have opposite signs, and a high diffraction efficiency can be realized over a wide wavelength band.

FIG. 5A shows a diffraction efficiency of the diffractive lens made of the first electro-active material, and FIG. 5B shows a diffraction efficiency of the diffraction lens made of the second electro-active material. From FIGS. 5A and 5B, it can be seen that light is diffracted into a plurality of diffraction orders in a visible range. Also, if the indicators of the orders are hidden, the two figures are very similar. This means that the peak wavelength of each diffraction order is substantially equal for the two diffraction lenses. In the diffraction lens made of the first electro-active material, the peak wavelength of diffracted light diffracted to the −2 order is 562 nm, and the peak wavelength of diffracted light diffracted to the −3 order is 441 nm. The height d1 of the first electro-active material is d1=9.2 μm. On the other hand, in the diffraction lens made of the second electro-active material, the peak wavelength of diffracted light diffracted to the 3rd order is 556 nm, and the peak wavelength of diffracted light diffracted to the 4th order is 445 nm, which is approximately equal to the above case of the first electro-active material. The height d2 of the second electro-active material is d2=27.5 μm. With such a configuration, it is possible that the light flux diffracted to the negative diffraction order by the diffraction lens made of the first electro-active material is diffracted to a larger positive diffraction order by the diffraction lens made of the second electro-active material, and then the electro-active lens 100 can diffract the light flux to a specific diffraction order (design order).

FIG. 5C shows a diffraction efficiency of the electro-active lens 100 obtained by combining the first electro-active material and the second electro-active material. As is obvious from FIG. 5C, compared with a liquid crystal diffraction lens 200 as a comparative example (FIG. 9), the diffraction efficiency of the 1st-order diffracted light is improved in a short wavelength and a long wavelength, and in particular the diffraction efficiency is greatly improved in the shirt wavelength side. As a result, it is possible to reduce flare due to undesired diffracted light (0th-order diffracted light or 2nd-order diffracted light), and it is possible to improve visibility.

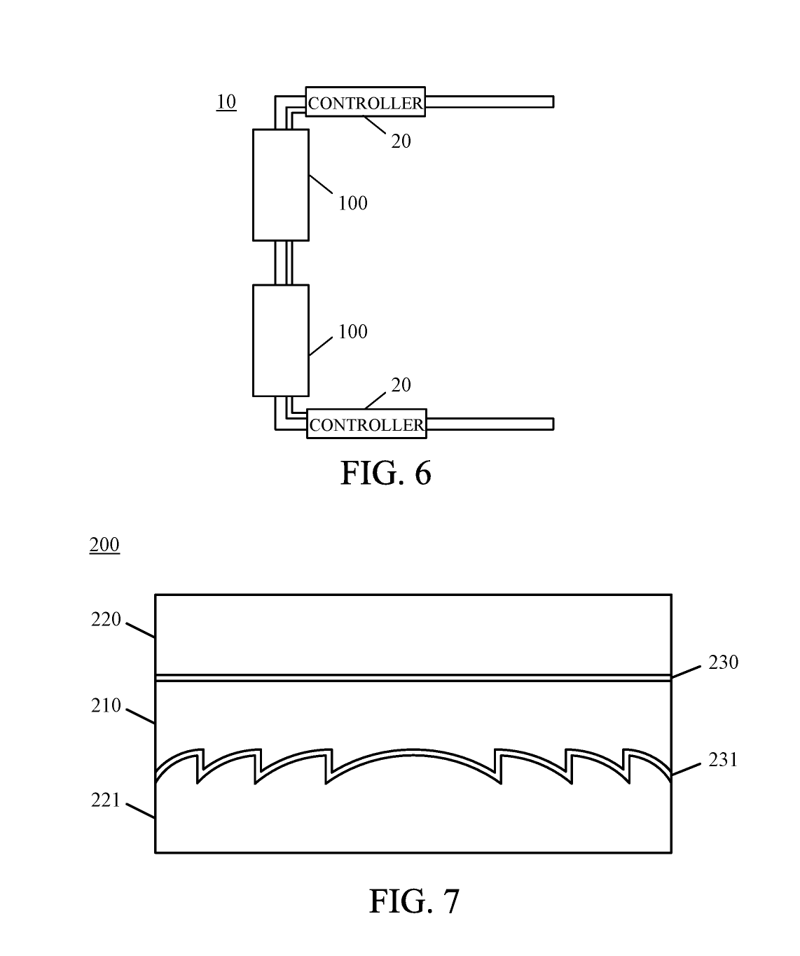

Next, with reference to FIG. 6, an optical apparatus having an optical element (electro-active lens) according to this embodiment will be described. FIG. 6 is a schematic diagram of the optical apparatus (eyeglasses 10). As shown in FIG. 6, the electro-active lens 100 is used as a lens of the eyeglasses 10. A controller 20 controls voltage applied to each of the first electro-active material 110 and the second electro-active material 120 of the electro-active lens 100 and switchably sets the electro-active lens 100 to an electro-inactive state or an electro-active state.

As described above, the optical element of this embodiment is an electro-active lens having at least two optical states, and it is possible to realize high diffraction efficiency in a wide wavelength band even in the electro-active state.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, the optical element (electro-active lens) of the present invention can be applied not only to eyeglasses for correcting presbyopia but also to various optical apparatuses such as binoculars and a head mount display.

This application claims the benefit of Japanese Patent Application No. 2017-198134, filed on Oct. 12, 2017, which is hereby incorporated by reference herein in its entirety.

What is claimed is:

1. An optical element switchable between a first state and a second state, the optical element comprising:
a first material having a first refractive index and a first Abbe's number; and
a second material having a second refractive index and a second Abbe's number,
wherein the following conditional expressions are satisfied:
n1>n2,
ν1<ν2,
Δn1>0,
Δn2<0,
Δν1<0, and
Δν1>0,
where n1 represents the first refractive index, ν1 represents the first Abbe's number, n2 represents the second refractive index, ν2 represents the second Abbe's number, Δn1 represents a variation amount in the first refractive index when the first state is varied to the second state, Δn2 represents a variation amount in the second refractive index when the first state is varied to the second state, Δν1 represents a variation amount in the first Abbe number when the first state is varied to the second state, and Δν2 represents a variation amount in the second Abbe's number when the first state is varied to the second state.

2. The optical element according to claim 1, wherein each of the first material and the second material is an electro-active material which varies between the first state and the second state dependent on an applied voltage.

3. The optical element according to claim 1, wherein the first state is an electro-inactive state, and the second state is an electro-active state.

4. The optical element according to claim 1, wherein the first material has a negative dielectric anisotropy.

5. The optical element according to claim 1, wherein the second material has a positive dielectric anisotropy.

6. The optical element according to claim 1 further comprising:
an alignment film in contact with the first material,
wherein the alignment film is a vertically alignment film.

7. The optical element according to claim 1 further comprising:
an alignment film in contact with the second material,
wherein the alignment film is a horizontally alignment film.

8. The optical element according to claim 1, wherein each of the first material and the second material has a birefringence of 0.1 or more.

9. The optical element according to claim 1, wherein a difference between the first refractive index and the second refractive index in the first state is smaller than that in the second state.

10. The optical element according to claim 1 further comprising:
a substrate provided between the first material and the second material,
wherein the following conditional expression is satisfied:
30 μm≤dsub≤300 μm,
where dsub represents a thickness of the substrate.

11. The optical element according to claim 1, wherein each of the first material and the second material is a cholesteric liquid crystal or a nematic liquid crystal to which a chiral twisting agent is added.

12. The optical element according to claim 1 further comprising:
a pair of first transparent electrodes provided so as to sandwich the first material; and
a pair of second transparent electrodes provided so as to sandwich the second material.

13. The optical element according to claim 1, wherein one of the pair of the first transparent electrodes and one of the pair of the second transparent electrodes are segmented electrodes, respectively.

14. The optical element according to claim 1, wherein the optical element is a liquid crystal diffraction lens having a variable focusing function.

15. The optical element according to claim 1,
wherein each of the first material and the second material is a diffraction lens, and
wherein a design order of the first material is different from that of the second material.

16. The optical element according to claim 17, wherein the design order of the first material and the design order of the second material have opposite signs to each other.

17. An optical apparatus comprising:
an optical element switchable between a first state and a second state; and
a controller configured to set the optical element to be in the first state or the second state,
wherein the optical element including:
a first material having a first refractive index and a first Abbe's number; and
a second material having a second refractive index and a second Abbe's number,
wherein the following conditional expressions are satisfied:
n1>n2,
ν1<ν2,
Δn1>0,
Δn2<0,
Δν1<0, and
Δν1>0,
where n1 represents the first refractive index, ν1 represents the first Abbe's number, n2 represents the second refractive index, ν2 represents the second Abbe's number, Δn1 represents a variation amount in the first refractive index when the first state is varied to the second state, Δn2 represents a variation amount in the second refractive index when the first state is varied to the second state, Δν1 represents a variation amount in the first Abbe number when the first state is varied to the second state, and Δν2 represents a variation amount in the second Abbe's number when the first state is varied to the second state.
